(19) United States
(12) Patent Application Publication
(10) Pub. No.: US 2006/0026086 A1
(43) Pub. Date: Feb. 2, 2006

(54) Industry specific business and tax management system

(76) Inventor: Harnsberger Jim, La Mesa, CA (US)

Correspondence Address: MICHAEL E. KLICPERA, PO BOX 573, LA JOLLA, CA, 92038-0573, US

(21) Appl. No.: 11/238,810

(22) Filed: Sep. 28, 2005

Related U.S. Application Data
(62) Division of application No. 10/682,765, filed on Oct. 9, 2003.

(51) Int. Cl. G06Q 40/00

(52) U.S. Cl. 705/35; 705/19; 705/1

(57) ABSTRACT

A business method that provides industry specific education programs and industry specific professional services programs having a predefined contractual relationship with at least one entity is described. The contractual relationship has terms whereby the business delivers the industry specific education programs and the industry specific professional services programs to the entity in response to receipt of a value from the entity. Both the industry specific education programs and the industry specific professional services programs are based on industry classification system defining occupations and tax classifications within an industry segment of an industry sector core.

### CROSS-REFERENCES TO RELATED APPLICATIONS

This application is a divisional of application Ser. No. 10/682,765 filed on Oct. 9, 2003.

### BACKGROUND OF THE INVENTION

(1) Field of the Invention

This invention relates to providing industry specific education and professional services programs to various entities.

(2) Description of the Related Art

In general, most individuals or businesses fail to properly manage and accumulate wealth due to a variety of reasons such as lack of knowledge in financing, accounting, business formation issues, or various federal, state, or local tax laws, or any or all combinations of laws or regulations that are of interest to an individual or a business. Unfortunately, even with a full knowledge, the individual or the business must be updated with the latest changes in all laws or practices related to their business interests. Wealth management is further complicated because it also requires full access to a variety of professionals specialized in their own field. In most instances, these professionals are not likely to be able to cooperate for proper representation of their client's full interest. For example, an estate-planning attorney should ideally coordinate his or her work with at least a Real Estate professional, a financial advisor, an attorney specializing in business formation issues (e.g. limited liability companies, corporations, etc.), and an accountant. Assembling such a “team” is very expensive for any size organization, including multinational corporations. Of course, even if an individual or a business does have the luxury of unlimited access to a team of professionals who are willing and able to coordinate their work for that individual or business, all their advise will be limited to the jurisdictions that they are allowed to practice. For instance, an attorney in one state jurisdiction will most likely fail to recognize business formation issues in another state jurisdiction. In addition, all members in this team of advisors must also be able to fully understand the “business” of their client to take advantage of any industry specific laws, such as those related taxes. Unfortunately, even full access to a team of professionals across all jurisdictional areas will not be enough for appropriate wealth management. This is the case because an individual or a business would also require access to a variety of services, including banking, credit, checking, or payroll services, or any or all combinations thereof that are of interest to the individual or the business.

There are varieties of financial or accounting software packages available today that provide rudimentary financing or accounting solutions. However, most software applications are generic bookkeeping or accounting packages, and are not specific to any jurisdictions, industry, or an individual's needs. Therefore, they cannot provide a complete business or personal wealth management solution to end-users. In addition, to correctly set-up and use these software systems, an individual or a business must have some understanding of financing, accounting, business formation issues, taxes, or any or all combinations of laws or other personal or business issues that are of interest to the end user. Further more, there are no software applications that can provide solutions to every aspect of every individual or business's wealth management requirements. Of course, there are also no software available that can provide legal or business counsel to its end user, no matter how complex or versatile.

Paramount among all the above mentioned concerns that individuals or businesses may have for wealth management is the constantly changing, difficult to follow, and very complex legal issues related to taxes. Tax laws are complex because every jurisdiction in the country has its own separate tax code. In addition, all tax laws are further divided by industry specific groups. Most tax advisors today provide a very limited, general tax advise to individuals or businesses. Tax advisors may have some understanding of federal, state, or local tax laws, but will most likely fail to recognize tax laws outside their state or local jurisdictions. This is an important problem facing most businesses today, especially those that have on-line Internet presence, and conduct business across jurisdictional lines. In addition, most tax advisors are not familiar with the “business” of their clients, and therefore fail in providing appropriate tax related counsel. As indicated above, tax code is not only jurisdiction specific, but also industry specific. A tax advisor will need to know a client's “business” before providing any counsel.

Chief among the issues that the Internal Revenue Service (IRS) identifies with individuals or businesses is the problem of adequate or proper records in case of an IRS audit. Most individuals or businesses fail to recognize the types of records to maintain and moreover, fail to identify a number of allowable tax deductions for legitimate business or personal expenses related to the specific business industry group due in large part to (1) a lack of knowledge and understanding about the U.S. tax laws; and (2) a lack of knowledge and understanding about the complex issues involving business related expense deduction requirements.

Additionally, tax professionals also fail to understand the complex issues involving legitimate business expense deductions with respect to specific industry groups, and compound the problem of reporting requirements for a specific business type. This compels their clients to be aware of all tax issues relevant to their field of specialty—a very unlikely scenario. Most professional counsels (including tax professionals) are not aware of the details of the business their clients are involved with, and their clients are not aware of various legal, insurance, tax and other business related issues specifically relevant to their business.

### BRIEF SUMMARY OF THE INVENTION

The wealth management system of the present invention provides a unique, novel and expansive variety of important business support systems for today's fast paced business owner, while allowing the business owner to be educated and trained within the comfort of their home or business office, without having to hire a wide variety of skilled professionals within each category of service the business owner may require or need.

The system and its Industry Specific Business Modules (ISBM) are a business system that incorporate a variety of mediums for delivery and support, while at the same time provide the delivery of many skilled professionals to assist the business owner from a one-on-one case, to a small, medium or large group web-based session.

The system of the present invention brings customized business support and services directly to the business owner, including staff support and training. It also brings interactive communication virtually around the world to the business using technology and communications support for delivery. In addition, it provides general business information on a variety of topics and issues, and specific business information based upon the type of business. Additionally, the present invention further provides for competitive pricing for services the business owner may desire, need or require for their business because of significant cost reductions attained through the unique methods of delivery provided within the business system of the ISBM design. This of course translates into lower costs associated with a variety of important services for the business owner for those services. These are but a few of the many benefits attained from use of the present invention.

A single business owner, an association of business owners, or individuals within the same industry group can use the present invention. In other words, a single business owner providing for example daycare services can use the present invention for that industry, or an association, which has several hundred or thousand daycare providers, can implement the present invention for their entire member association.

A specific association, which has many members of the same type of business, can use the present invention because it can be customized to provide all the support necessary for that industry and the specific association members. Companies providing single service products to business owners can utilize the present invention for customer support to their client base and customize product training, product information, customer support and education as well as a variety of other services required by the clients of the firm.

The unique aspect and novel application of the present invention is the capability to provide industry specific training and support for today's business owner, through ISBM. In addition, the business owner can be both a consumer of the present invention as well as a “provider” in that the business utilizes one level of the system design for its varied needs, while at the same time providing different service and support to its staff, customers or prospects. This multi-versatility of the present invention makes the ISBM both unique and innovative.

Business owners within a specific industry group do not have to be limited by the constraints of geographic restrictions due to the utilization of modern technology and communication that virtually extends the reach of the present invention to a global audience versus a small geographic community audience. The other unique aspect of the present invention however enables the system to provide yet further industry specific training and support for only those within the a specific jurisdiction area taking into account local regulatory issues that will vary greatly from jurisdiction to jurisdiction.

These and other features, aspects, and advantages of the invention will be apparent to those skilled in the art from the following detailed description of preferred non-limiting embodiments, taken together with the drawings and the claims that follow.

### BRIEF DESCRIPTION OF THE DRAWINGS

For purposes of illustration, programs and other executable program components are illustrated herein as discrete blocks, although it is recognized that such programs and components may reside at various time in different storage components, and are executed by the data processor(s) of the computers.

It is to be understood that the drawings are to be used for the purposes of exemplary illustration only and not as a definition of the limits of the invention.

Referring to the drawings in which like reference numbers present corresponding parts throughout:

FIG. 1 is an exemplary illustration of the overall business system in accordance with the present invention;

FIG. 2 is an exemplary illustration of a classification system of various entities in accordance with the present invention;

FIG. 3 is an exemplary illustration of a sample industry specific educational system for each industry classified entity illustrated in FIG. 2 in accordance with the present invention;

FIGS. 4 to 7 are specific detailed illustrations of a few exemplary educational modules of FIG. 3 in accordance with the present invention;

FIG. 8 is an exemplary flowchart illustrating the industry specific professional services programs in accordance with the present invention;

FIG. 9 is an exemplary flowchart illustration of a mere sampling of different types of industry specific professional counsel available to entities in accordance with the present invention;

FIG. 10 is an exemplary flowchart illustration of different business records accessed by entities as well as professional counsel in accordance with the present invention;

FIG. 11 is an exemplary flowchart illustration of a typical access method to different records by both professional counsel and entities in accordance with the present invention;

FIG. 12 is an exemplary illustration of a customized general ledger, showing a representative list of few expense categories for daily record keeping in accordance with the present invention;

FIG. 13 illustrates a well-known method of access to the educational as well as the professional services programs of the present invention;

FIG. 14 is an exemplary illustration of the libraries and resource centers that may be used by professionals as well as entities, including clients in accordance with the present invention;

FIG. 15 is an exemplary illustration of some of the specific topics covered by an on-line video library in accordance with the present invention;

FIG. 16 is an exemplary flowchart illustration of the educational programs delivered in a well known method of live on-line interactive system in accordance with the present invention;

FIG. 17 is a specific exemplary illustration of a typical live on-line interactive session between a professional counsel and an entity.

### DESCRIPTION OF THE INVENTION

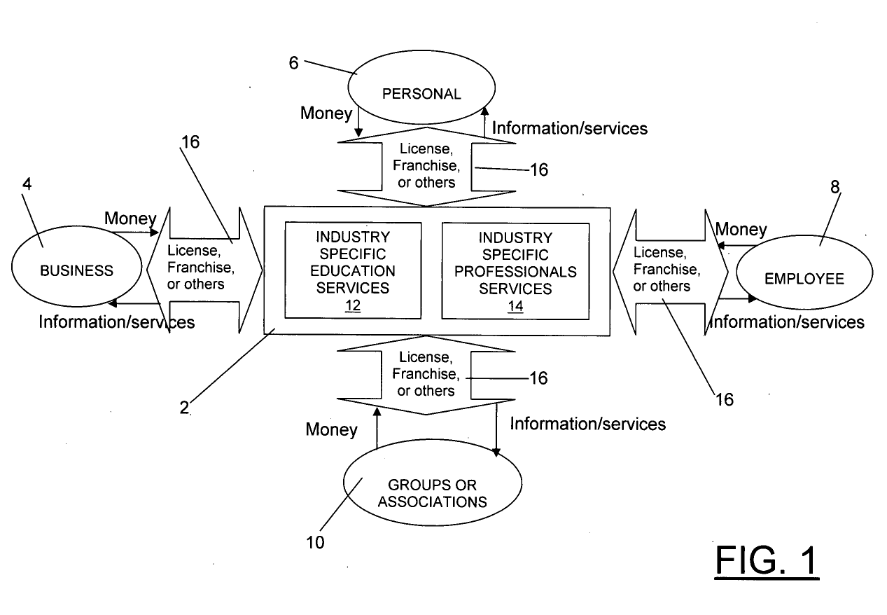

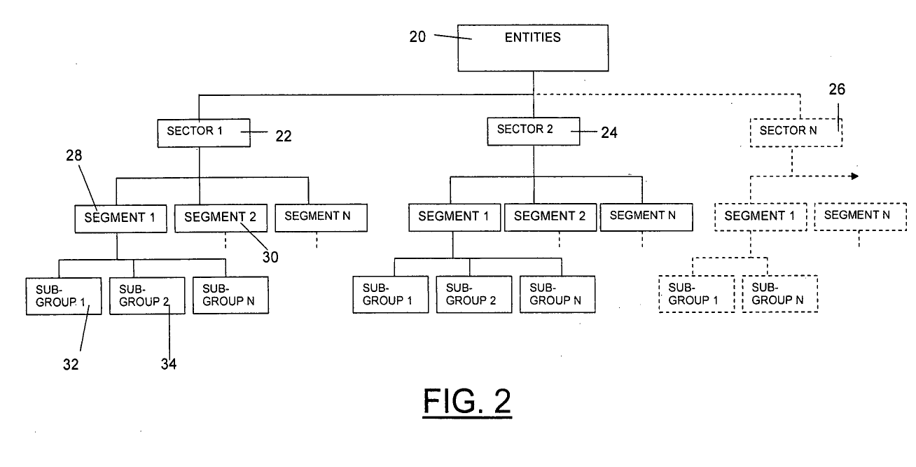

The industry specific personal and business wealth management system 2 (hereinafter “system 2”), illustrated in FIG. 1 provides both industry specific educational services 12 and industry specific professional services 14 to various entities 20 (shown in FIG. 2) such as businesses 4, individuals 6, employees 8, and groups or associations 10 based on agreements 16 between the system 2 and each entity. The groups or association 10 may also be considered as institutional entities that work with system 2 under agreements 16. Revenues for system 2 are derived from the services 12, 14 provided to each entity 20 based on agreements 16. System 2 is fully modularized by specific economic sectors based on an industry classification system of the present invention such as industry sectors, segments, groups, and types, and can readily be accessed by any entity 20 across any jurisdiction. Accordingly, all of the services provided by system 2 are available to all entities through agreements 16 for fees. These fees used by system 2 cover that year's audit protection for participant entities as part of their member (enrollment) benefit. The members of system 2 also pay a continuous fee for access to educational programs 12, industry specific professionals programs 14, protection and asset recovery, and other business related services. These other services may include, but should not be limited to, for example, entity formation services based on industry specific ISBM models, entity support services such as specific minutes and resolutions for the business entity based upon the uniqueness of the business industry; employee wage classification analysis, all using the established methods developed.

Central to the present invention are solutions to various business issues in general and tax-related issues in particular. For example, in response to IRS's extensive auditing techniques aimed at specific business industries, the present invention provides an Industry Specific Tax Module (ISTM), which is a designed application of multi-tasked record keeping and tax return preparation modes specifically designed for any entities within specific industries and types. The system 2 provides entities with industry specific education 12, practical hands-on assistance through professional services 14, protection and recovery of assets, and other services described below. Both the educational programs 12 and the industry specific professional services program 14 allow access to professionals who are specialists in the specific industry and type that the entity is interested. In addition, the assistance by the professional services program 14 enables entities access to a plurality of services such as banking, credit, checking, payroll, taxes, or any or all combinations of legal or other personal wealth issues or business services that are of interest to an entity. These may include, but should not be limited to, for example, insurance, law, marketing, development of trust, financial (retirements, investments, etc.), and others described below in more detail. The protection and recovery of assets within the system 2 industry specific professional services program 14 allows recovery of lost assets due to a variety of reasons, including asset loss due to tax audit for incorrect filing of returns. The system 2 may be accessed through any known medium in a variety of well known formats appropriate to the topics discussed in both the education 12 as well as the professional services program 14. The formats may include print, digital, audio, video, visual, on-line, including live on-line sessions, or any or all combinations best suited for the subject matter under discussion.

FIG. 2 is an exemplary illustration of an industry classification system of various entities 20 in accordance with the present invention. The classification system identifies unique issues related to each industry classification leve—issues related to a variety of unique challenges for each entity 20. Through the specific identification of the entity class within an industry classification system of the present invention, the system 2 can provide targeted defined planning objectives and strategies that will provide far greater efficient savings, reduction of costs, and increased overall economic performance. The industry classification system of the present invention identifies an “industry sector” (e.g. the construction industry), then defines “industry segments” within that industry sector (e.g. painting companies, roofing companies, etc.), and it further defines worker classifications within each of the industry segments to the industry sector (e.g. roofing installer, clerk, tar crew, etc.) to provide the industry specific educational 12 and professional services 14 programs of system 2. The industry classification system provides a comprehensive overview of the entire operations of a specific industry segment's business with a focus on the issues of taxation affecting that entity. The industry classification system of the present invention is unique in that it covers all entities, i.e. businesses, associations, and individuals that work for them.

The present invention has recognized that each industry segment or worker classification has unique aspects or issues specific to that classification level that must be evaluated regardless of the industry sector core. For example, each employee classified within the industry segment of roofing has an identified worker class code that provides information about job description. Using that code the present invention identifies the nature of employment, its relationship to the various entity industry classification levels, evaluates the various tax strategies that may be employed and provides specific integrated opportunities based upon the efficiencies of this relationship. As another example, the classification system of the present invention may be used to identify each inter-relationship between the employer and the worker in terms of a variety of issues that may provide planning opportunities to increase efficiency, lower operational costs, and in turn increase the opportunities for building profits as part of the tax and business planning process of the present invention.

The education 12 and the professional services programs 14 of system 2 are truly industry specific, based on the industry classification system of FIG. 2. Both the educational 12 and the professional services programs 14 of system 2 are unique in that they create awareness defined by specific industry classification to the important tax or other business considerations that so often consume financial resources through inefficient control of revenues. Moreover, the identification of these and many other issues within the classification of industry in accordance with the present invention provide specific strategic opportunities to add to and contribute in the process of bringing economic efficiency, which in turn contribute to the lowering of overall costs. As a specific example, the industry classification system of FIG. 2 may be used by both the education and professional services programs 12, 14 of system 2 to select an industry sector (e.g. construction), and then an industry segment (e.g. roofing) within that sector, and then from this selection define the various issues impacting the business for use in tax planning, business operations, and other related core industry segment issues of the business. This provides a single collective source of unified information to define the total level of taxation, operations, and financial management tools designed by the industry segment for both the business as well as the classes of workers within the business.

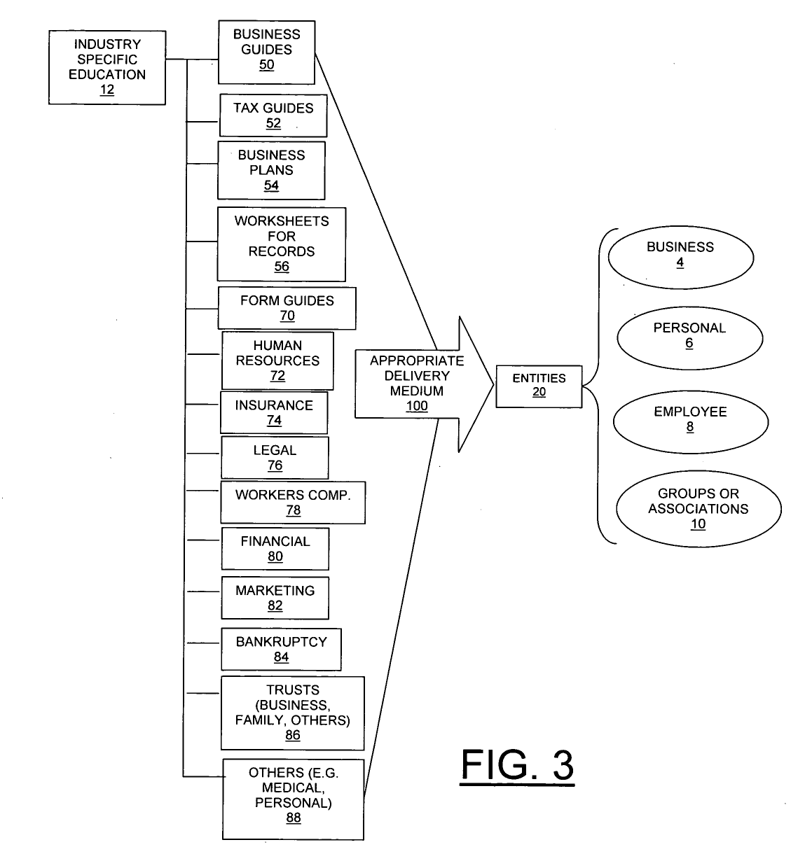

FIG. 3 is an exemplary illustration of a sample industry specific educational system for each industry-classified entity 20 illustrated in FIG. 2 in accordance with the present invention. The system 2 (both the educational services 12 and the professional services programs 14) identifies important issues by industry type (classified in accordance with principles illustrated in FIG. 2), and focuses strategies based upon the class levels of the industry core. As an example, the roofing industry segment of the construction industry sector will received specific industry segment education related to the roofing industry. This may include, but is not limited to, for example, tax issues for roofing companies, such as entity operations, tax strategies, business guides, tax guides, audit guides, etc. that are specifically related to roofing contractors. More specifically, they may include issues related to wage and hour analysis for determination of accountable reimbursement plans, working condition fringe benefits, insurance, or human resource issues specifically related to roofers. Just the issues related to taxes regarding the roofing industry segment may include, but not be limited to, for example, issues related to entity type, income tax, property tax, employee tax, sales taxes, states taxes, and others.

FIG. 3 illustrates the various educational modules aimed at entities for specific business education relevant to their field of work, based on the industry classification system of the present invention. The education programs 12 of system 2 take into consideration all business related issues relevant to all specific industry groups, types, and jurisdictions for wealth management. Some of the modules of the educational programs 12 include for example, business manuals 50, tax guides 52, business plans 54, guides to a variety of worksheets and business records 56, and other topics of interest illustrated. Examples of a few specific industry groups covered by the programs 12 include such businesses as day care centers, retail stores, service industry groups, multi-level marking direct sales (MLM) companies or affiliates, consultants, etc. Of course, this list is not exhaustive.

The educational information related to the specific types of businesses covered by the educational programs 12 also include all topics related to all kinds of business formation issues. The focus of this information is on different types of business entities (or business formations) within specific industry classes and jurisdictions. To illustrate, a consultant will learn that an incorporated consulting firm has different legal or financial benefits compared to a proprietary or a limited partnership consultant company. In addition, the consultant will also learn that an incorporated consulting firm in one jurisdiction will most likely have different tax requirements compared to the same at another jurisdiction. Further more, the consultant will also learn that certain types of business formations are not allowed for specific industry classes within particular jurisdictions. The program 12 will therefore provide all entities with the tools to identify the best type of business formation within any specific industry class and jurisdiction. This same level of detailed, industry specific education is provided to any participant within all the modules illustrated in FIG. 3. For example, the insurance module 74 for a physician with a private practice will include materials specific to medical professionals within a particular jurisdiction. Within this module 74, the medical professional will learn about the types of insurance required for their field of work, including any jurisdictional requirements for insurance where they have their practice. In this manner the physician as well as the insurance provider can evaluate the insurance needs, and determine the most cost effective method to spread risks among specialty insurance companies, compressing total overall risks associated with equipment loss, business liability loss, business income loss, building loss risks, and other loss potentials unique to the business. Therefore, the integration of more efficient management and administration of the business using the system of the present invention contribute to overall reduction of typical risks. All materials covered by all the modules illustrated in FIG. 3 are industry specific based on the industry classification system of the present invention. Accordingly, for example, the insurance material covered by module 74 for a physician will differ from those covered for a day care provider or a roofing contractor.

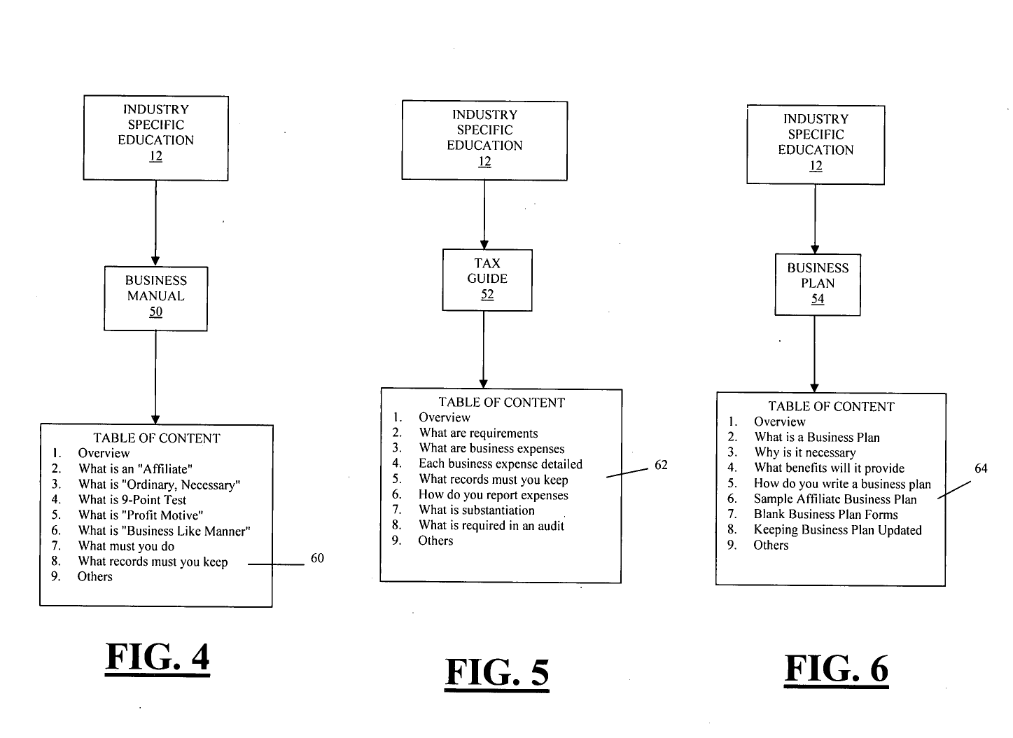

FIGS. 4 to 7 are specific exemplary illustrations of the general contents for a few specific modules of the educational program 12 of system 2, shown in FIG. 3. The educational contents of all components will vary depending on different business categories (or classification) such as a business's specific industry group, type, and jurisdiction. In addition, they also include the latest changes (updates) related to all aspects of the business within those categories. These may include changes in industry specific regulations, taxes, new requirements for business plans, changes in record keeping rules, etc. As a specific example for the contents of a typical module shown in FIG. 3, FIG. 4 illustrates the general content 60 of a typical business manual 50 currently used for training of businesses or individuals interested in direct selling. This manual explains in detail the various elements and requirements that must be met in order for an “Affiliate” to be entitled to tax deductions for operating a direct selling business under current tax laws. FIG. 5 illustrates the tax guide module 52 of FIG. 3 as another example of a typical educational component currently used for training those interested in direct selling. This guide explains in detail different requirements for tax reporting purposes for all direct sellers. FIG. 6 is yet another specific example of a module illustrating the general content 64 for a representative business plan 54 (shown in FIG. 3) used currently for training purposes. The plan 54 explains in detail how to write a business plan, and includes sample plans and blank forms. FIG. 7 illustrates the general content 66 of a typical worksheet manual 56 of FIG. 3 currently used for training businesses or individual interested in direct selling. Worksheet manual 56 explains in detail the worksheets designed for record keeping purposes. Each educational module illustrated in FIG. 3 will have a corresponding set of educational material, similar to the above specific examples. The delivery of the educational material to the program 12 participants will be via any appropriate delivery medium, including the Internet.

The industry specific educational programs 12 for tax professionals, which mirrors those of others, in addition includes information about operations, marketing, and practice and procedure (tax law) for a tax consultant. A tax professional may be defined as one that prepares, files, or provides advice on tax issues. The program access is provided under enrollment by the tax professional into selected program, and a license is granted to the professional to authorize access use, and integration of all the program assets as defined under each program description guide. The license granted also provides authorization for the tax professional to sell any of the various audit protection programs developed, and earn commissions on a periodic gross revenues generated from these sales. The educational program 12 for the tax professionals offers practice evaluations, fees and revenue analysis, fee billing codes, marketing program, and professional service classification and tracking system. The professional services classification (PSC) determines the services provided by the professional, and analyzes the services potential of the firm. It uses a formatted methodologies (described below) to determine the revenue potential based upon the firms “client classification” in order to determine the revenue potential of a given tax practice. It is used to guide the professional in a manner necessary to understand the composition of the firm's client database. Client classifications are established using a coding system to determine the industry specific types of clients within a given firm, then matching this database with the various resources available through the system.

The operations part of the tax professional education includes study material about the operations of a tax service office. System 2 educates the tax professional on methods of evaluating the profiles of all their clients using a database to classify and rank their clients based on their tax return profile. Return profile of a tax office client comprises the number of tax forms and schedules used for a specific client, the types of tax forms and schedules used as it relates to market segment in an industry core, and others. The profile provides the tax professional with information about the value of their practice through practice fee evaluation. The practice fee evaluation informs the tax professional the exact value or worth of their practice, and the correct fees that should be charged for any specific tax services provided. The tax professional educational program of system 2 has also developed a fee coding system for the tax professional to charge clients based on this code. Hence, everything done in a tax office in an uniformed approach under system 2 has a specific fee code, which take the guesswork out of the evaluation process of what a client should be charged for a specific tax service. This fee code is also based on the industry specific classification system illustrated in FIG. 2. A typical example for a fee code for home repair industry segment is “TXPREP-CY-0200”, which describes tax preparation services for a current year tax return involving a home repair company, where the coding -0200 ties the industry to the fee to track revenue based upon the specific work. Yet another specific example, the tax preparation for a prior year involving a typical day care provider client may be represented by the code “TXPREP-PY-0400”.

System 2 use two methods to evaluate the worth or value of tax services practice, both of which are based on the industry specific classification system of the present invention illustrated in FIG. 2. The square foot method uses the size of the tax office to determine the maximum (or most) dollars that may be generated therefrom. Tax professionals may also use this method to determine how much more value will be added to a tax office if the physical dimensions of the office are enlarged. The following formula is used by this first method to determine the worth of a tax service practice.

Where

AR=Annual Revenue

$$ARSQ = \frac{AR}{TSQ} \qquad ( 1 )$$
TSQ=Total Square Foot of a firm
ARSQ=Annual Revenue per Square Foot of the firm.

The monthly revenue per square foot of the firm may be obtained by simply dividing the annual revenue per square foot (ARSQ) by the number of months in a year.

$$MRSQ = \frac{ARSQ}{12} \qquad ( 2 )$$

Where
MRSQ=Monthly Revenue per Square foot.

The equation (2) may be used to establish a guideline for the firm to evaluate revenue based on fixed lease space that is measured by the monthly cost (MRSQ) of the lease per square foot area. Assuming a minimum revenue baseline multiplier value (Bv) times this cost, it could be determined that the costs associated with operations within a given space will be as follows:
C=Bv×MRSQ
Where Bv is the baseline value arrived at from the weighted averages of revenues derived from clients of a tax office based on industry segment, and C is the monthly per square foot Cost of the least space. The baseline multiplier Bv is determined by the following:

$$Bv = \frac{F}{R} \qquad ( 4 )$$

Where F is weighted average fee for tax services based on the client industry classification system of the present invention, and R is last year's revenue of the tax office. As a specific example, if last years revenues R were 74,560.00, and the weighted average fees or revenues based on the industry classification system of the present invention are 187,455.00, then the baseline multiplier value Bv would be 2.51. The value for the baseline multiplier Bv will differ depending on the client tax return profile and client industry classification. For example, tax offices with a majority of their clients classified in the construction industry sector would have a higher baseline multiplier value Bv than those with clients who simply work for an organization as employees with no complicated tax issues.

The methodology for deriving the baseline multiplier value Bv may also be used to evaluate and determine the value of a tax firm in the event of purchase opportunities, based on Return On Investment (ROI). Accordingly, the tax professional may use this methodology to make a business decisions regarding the purchase of an existing tax firm or the firm's clients. Using weighted average industry segmented fees F from equation 4 above, the tax professional may determine if the firm being sold is undervalued in price, and determine the amount of ROI. As a specific example, in general, most tax firms are usually sold at about 1.0 to 1.5 times their prior year revenue. Assuming exemplary revenue of about $100,000.00, a tax firm may be sold for 1.2 times this revenue or about $120,000.00. However, the exemplary $100,000.00 revenue is not industry classified or segmented, and does not provide a correct information regarding the actual or true revenues of the firm. Accordingly, using equation (4) above, the true revenue potential of this firm based on the fees per industry segment (represented by F in the numerator) may be much higher or lower. For example, Real Estate industry sector clients of a tax office in accordance with the fee coding and classification system of the present invention will and should produce a higher weighted average fees for the tax office than those clients who simply work for an organization as employees with no complicated tax issues. Therefore depending on the client classification (client profile), a tax office with more clients classified in segments of the industry that produce higher weighted average income will and should be worth more. Assuming an investor pays the selling price of $120,000.00, but the firm has a true potential to generate $187,600.00, which is the income determined based on the weighted average industry segmented fees F, the dollar value of the return will be $67,600 increase in revenues above the base line sale price (an ROI of 56.3%). That is, the revenue of $187,600.00 is 1.88 times last year's revenue of $100,000.00. As described, weighted average industry segmented fees F serves two functions, to determine the multiplier for the Square Foot analysis and the valuation on ROI for the purchase of a tax office.

If the monthly revenue per square foot, MRSQ is less than the cost C (equation 3), then obviously the annual revenues AR is too low. As a specific example, a professional considering an office space of 1200 square feet that has a cost of $1.25 per square foot would have a yearly fixed lease cost relative to the area under lease of about (($1.25*4*12*1200)=$72,000). This analysis, using a baseline multiplier 4, illustrates to the professional that a minimum annual revenue to operate the firm must be $72,000 in order to safely operate the firm and support the fixed lease costs. Other variables are taken into account in revenue considerations.

The square foot cost analysis methodology simply provides a guideline to determine if the space will support the revenue potential of the firm and meet the fixed lease costs. Accordingly, if a tax office under performs in accordance with this method, the educational programs 12 of system 2 for tax professionals can teach the tax professionals how to make the most efficient use of their office space, with expense models and tracking models to operate their practice using fee codes (described above) and using record keeping system that is unique to the tax professional. Expense models simply determine and group various expenses into direct and indirect costs related to the operations of the firm. All direct costs are tied to the firm in order to evaluate its ability to operate on a 65% to 70% GPM (Gross Profit Margin). For example, if $72,000 is the fixed space costs, and 65% is the target GPM, revenues will need to be at $118,000 (72,000 *1.65). The model can also establish through evaluation of direct and indirect costs associations portions of the direct costs attributes that can be reduced by establishing more efficient cost models to control direct costs associated with providing tax preparation services. For example, the per client or per return fixed costs enable the tax professional to establish a fixed cost amount necessary to maintain a 65% GPM simply by paying the tax technician based upon revenues generated so that the relative costs are fixed and tied to the revenues using the fees established for the firm.

The second method is the dollar ratio method, which uses the dollars per clients, and dollars per client return profile to determine the worth or value of a practice. The dollars per client ratio provides information about average gross dollars that a tax office generates per client. Fee evaluations use the dollar per client return profile ratio. This ratio provides information about clients that bring more value to the business than others in terms of their tax business dollars for the tax professional. For example, how much more profitable are day care clients vs. construction clients. The cost factors for day care provider returns are different for construction returns because the worksheets, the forms, the integration of all other parts is different for each industry segment. The time it takes to do a tax return for each industry segment is different. Using the fee codes (described above), the practitioner therefore knows how to track and monitor cost to control profitability, but more importantly, how to evaluate whether he is charging enough for the actual tax work done for that specific industry segment client.

The marketing aspect of the tax professional educational program 12 of system 2 comprises the integration of all the program segments for each industry to enable the tax professional to penetrate specific markets. One example of marketing tools for the tax professional is to create a series of tax tips unique to the segment of the indicatory sector core. This provides insightful industry specific tax tips to their clients. Another example of marketing tool is to provide free consultation for a review and an analysis of client's tax return based on a proprietary model to find all its errors and the omissions. The tax professional will then develop a tax strategy unique to client based on the return and the client position in the segment of the market and the industry core. The proprietary model for review of a tax return is a process by which the tax professional is trained under program 12 of system 2 to evaluate the accuracy of the tax return based on the market segment and industry sector core. The process for the model is an industry segment review and analysis (ISRA). The ISRA identifies the industry sector, than identify the industry segment within the industry sector, than through a reference guide evaluates clients' tax return. The reference guide is specific to the industry sector and industry segment. For example, day care providers operating at home have a reference guide for all the deductions allowed. The guide also includes all the errors and omissions that are most common on the tax return for home based day cares, including various tax formulas, the computations, methodologies, and processes for completing an accurate review of the return to determined error and omission. The completion of the review of clients' returns leads to development of a tax Performa, informing the client about tax inefficiencies.

In practice and procedure, the system 2 educates the tax professional about tax law that includes specific industries that the tax professional has targeted to provide services. For example, the educational program 12 may provide tax-related information that teaches about tax issues relevant to day care providers. In this case, under program 12 of system 2 the tax professional will learn about all tax related issues relevant to day care provider, including secondary tax issues such as those illustrated in FIG. 3. The industry specific educational program 12 of system 2 provides an insight into the day-to-day operations of any entity classified within the industry classification system illustrated in FIG. 2. This way, regardless of the client's understanding of tax issues relevant to their specific industry, the tax professional is able to provide highly specialized tax advice that specifically meets the needs of their client.

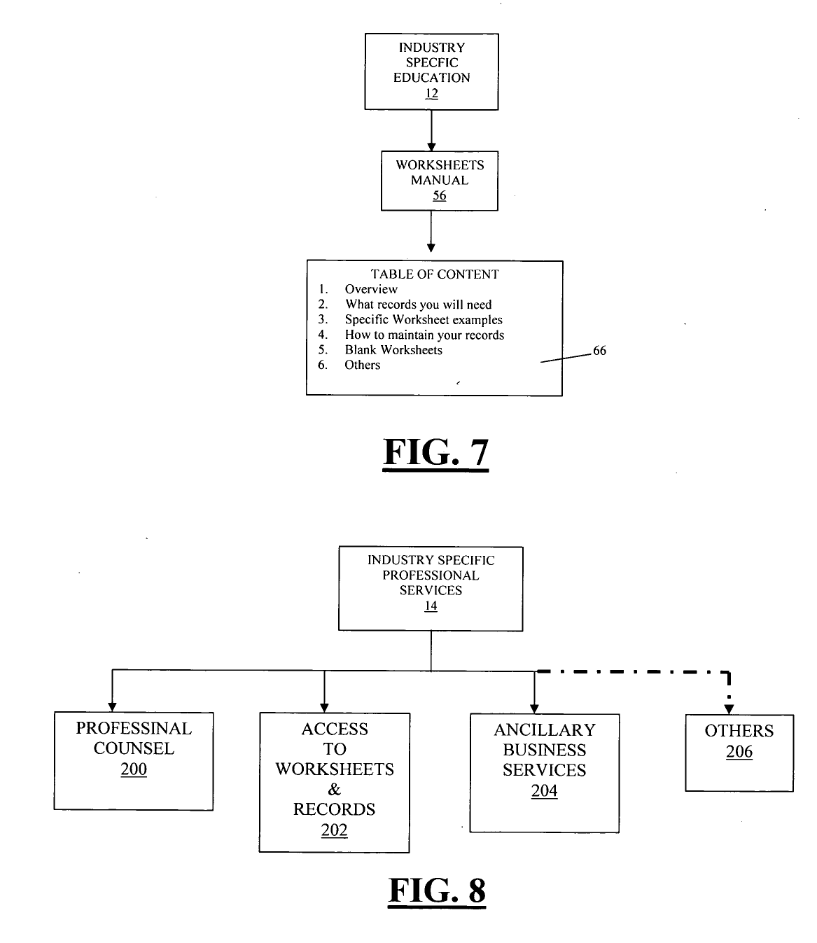

Various details of industry specific professional services programs 14 are illustrated in FIG. 8, and comprises of applications and systems that readily provide industry specific hands-on assistance to entities. These may include industry specific professional counsel 200, access to industry specific worksheets and records 202, ancillary business services 204, and others 206 that will be described below in more details. Ancillary business services 204 may include those related to banking credit payroll, working condition fringe benefit analysis, business credit, business insurance, etc.

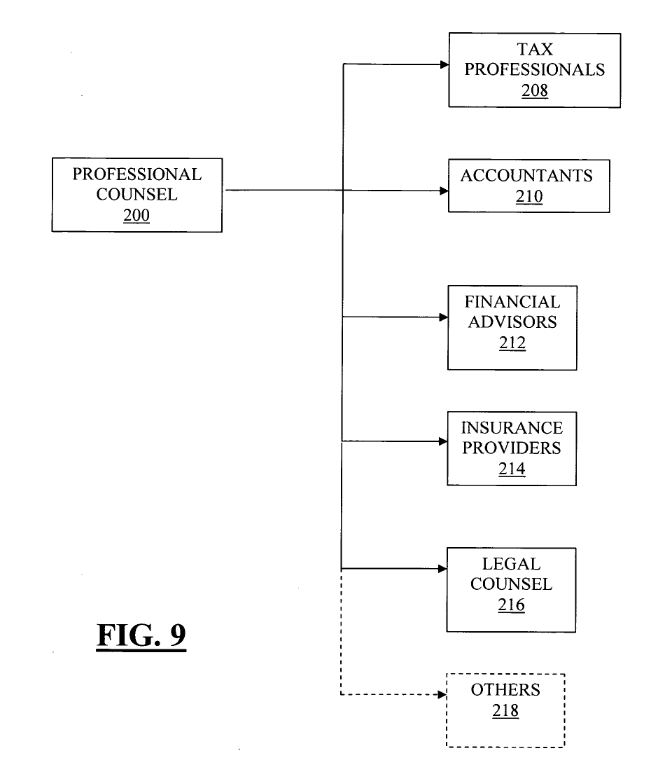

FIG. 9 illustrates different types of industry specific professional counsel 200 available to entities through the system 2. All counsel 200 have expertise in their own field of specialty, and appropriate training through system 2 educational programs 12 with respect to specific industries for which they may provide counsel. They are also participants within industry specific professionals program 14 of system 2 under agreement 16, generating fees for system 2. Other professionals 218 may include those who counsel on matters that requires specific knowledge of a business the entity is interested. For example, they may include professionals who can provide hands-on assistance with writing a business plan for a specific business. Industry specific professional programs 14 allow entities full access to professional counsel across all jurisdictions. An entity may for example have access to legal counsel 216 with respect to business formation issues for any jurisdiction. Tax professionals 208 may be accessed from any location for personal or business related tax advice for a particular business within a specific industry classification group, type, and jurisdiction.

All professional counsels 200 are trained within the industry specific educational programs 12 of system 2, and are members of the industry specific professionals programs 14. For example, an insurance provider 214 will be trained about the specific needs, requirements, and operations of a roofing company. A legal firm 216 may also be trained in the same. Hence, every professional will learn about specifics related to targeted markets that they wish to penetrate. Once taught, these professionals gain expertise in all issues related to that specific industry. The legal firm 216 will know all business-related issues of a roofing company. This information provides an invaluable tool for the legal professional and the business owner alike, while at the same time contributes to reducing the exposure to risks for legal issues unique to the business through effective management and administration of these important legal issues unique to the specific business segment. The insurance provider 214 will learn all business related issues (exemplary list of issues provided in FIG. 3) about home based day care providers. This enables the insurance professional 214 to penetrate this market to provide and expand its business to all day care providers. Hence, not only a day care provider can go through the educational system 2 as described above, the professionals who wish to provide advise within their own field of expertise to day care providers may also learn about all aspects of day care business, this way the advice provided by the professional to the day care provider will be targeted industry specific advice.

The membership to programs 14 of system 2 may be under an agreement 16 that may take any form, including, but not limited to, licensing, franchising or other agreements that is best suited for the professional to delivery system 2 to entities. This may for example include a temporary agreement on a project basis. All agreements (under both educational and professional programs 12, 14, respectively) will generate fees for system 2. For example, most tax professionals 208 trained by system 2 may also become professional members 14 of system 2 as franchise units. These units provide a variety of services, including, but not limited to, tax advise for all taxes across all jurisdictions, audit protection, personal loans or mortgage reduction tools, business formation strategies, tax reduction tools unique to specific industry group and type, or any or all combinations thereof. The audit protection programs within the industry specific professional programs 14 provide an entity full, unlimited representation in audits. The audit protection programs may include at least a first level “Personal Audit Protection Model” that every entity receives in addition to a second level “Business Audit Protection Model” covering any tax return in the business. The first level of the personal audit protection program factors for representing only an audit notice received by the client. The second level factors for representing any notice from any tax agency the client may receive. Risks associated with level 1 are far less than level 2 simply because of the limitations for representation of only an audit notice. The pricing for level 2 is more attractive to the consumer, including risk management of the exposures in terms of paying a given firm for representation. Other levels allow a member to cover prior years as well, or upgrade for an eventual pre-paid legal component. In general, the audit protection representation is handled by a tax franchise or licensed unit or trained tax professional 208 authorized (and trained) under both the educational 12 and the professional 14 programs of system 2, nearest the entities jurisdiction under agreement 16 (illustrated in FIG. 1). The entities may access any audit professional through a variety of different methods, including on-line. The tax professionals under agreement 16 address potential audit issues that IRS may review during a routine audit of tax return, and provide guidance to individuals, businesses, and tax professionals about the complex rules related to tax issues, including for example, record keeping and substantiation before any audit takes place. All advice is based on industry specific classification system illustrated in FIG. 2.

During an audit, the tax professional 208 will provide the entity with a tax review and analysis based on the information obtained from entity 20, and write a short memorandum of findings, which point out all errors and omissions with respect to the taxes filed. In addition, the tax professional 208 will also file a new claim under the rules of the IRS or any other jurisdictions, and amend the entity's return, and recover any money due, plus interest. The entity 20 is also referred to legal counsel 216 for malpractice to recover incurred damages due to negligence of prior tax representation.

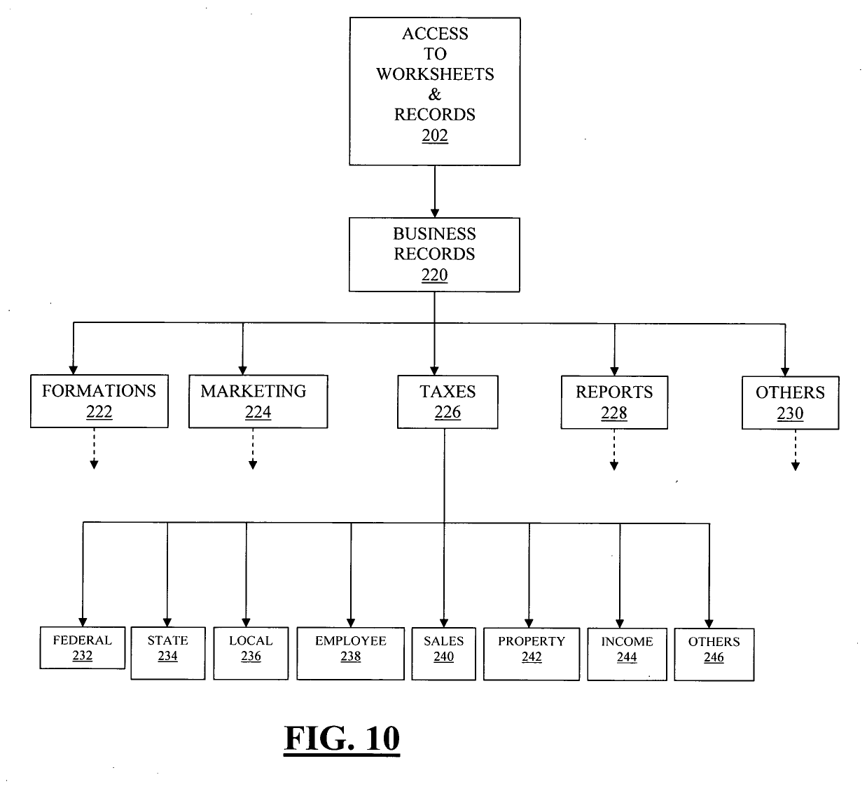

The system 2 comprises of applications and systems that readily provide accurate information about the economic condition of individuals or businesses. It provides a variety of record keeping systems and services that are customized for each individual or business within specific industry groups. FIG. 10 illustrates a general overview of different business records that may be accessed by entities 20 as well as professional counsel 200. Business records 220 accessed by all relevant entities may include records related to business formations 222, marketing 224, taxes 226, reports 228, and others 230 that may relate to an industry specific business group and type. Entities 20 are provided with record keeping systems and services that are facilitated through a variety of software applications available. The system 2 provides an efficient means by which the entity 20 as well as the professional counsel 200 may interact with various databases, including certain business records 220 for review of all business related transactions. This may include records related to taxes 226, such as review of deductions for correctness in terms of reporting requirements. System 2 can also generate a variety of customized business reports for entities that fully comply with all legal reporting requirements for any jurisdiction. These may for example include today's “ordinary and necessary” requirements of the tax code. In addition, all records 220 are also continuously updated to meet the ever-changing business requirements.

The tax records system 226 for an individual or a business provides tax related documents that comport to various industry specific, type, and jurisdictional requirements for taxes. These may include for example record keeping systems and applications that comport to the record keeping requirements of different tax jurisdictions for tax reporting purposes, including the IRS. Within each industry specific group (as classified), type, and jurisdiction, the entity 20 has an application for identification of a variety of tax deductions within that industry grouping, type and jurisdiction that will reduce overall taxes the entity 20 may otherwise have to pay.

The tax records system 226 also provides a design application for recording business transactions that will meet both the record keeping as well as substantiation requirements imposed by the tax laws. The tax records system 226 of the present invention ties together a variety of tax related issues, including the recording of business transactions for a specific business type to match the reporting requirements of different tax jurisdictions with an understanding of the rules for deducting specific business expenses, or business expenses that may be unique to that specifically industry classified business. The system identifies every tax issue affecting the business, and then establishes a records management system to monitor how each of these taxes are computed. This includes various elements that are factored into the basis for imposition of the various taxes, and other issues (if any) that can mitigate all or any portion of a given tax affecting the business. Thus, the methodology provides more efficiency in the control and administration of all taxes affecting the business no matter what jurisdiction the business may be situated.

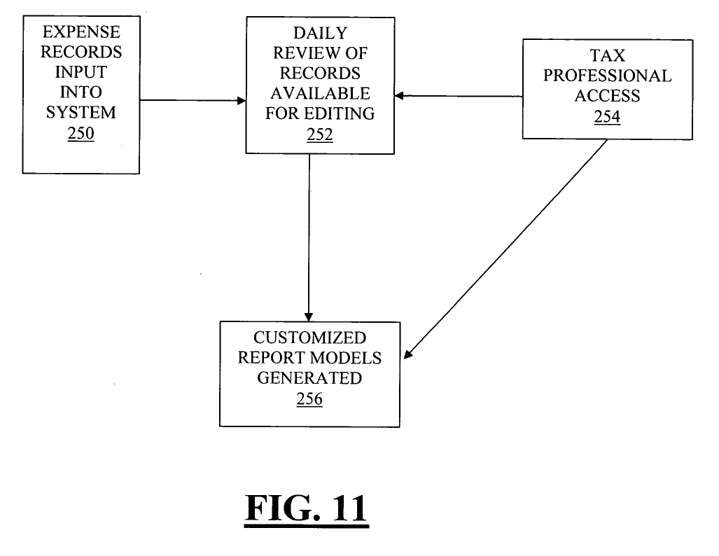

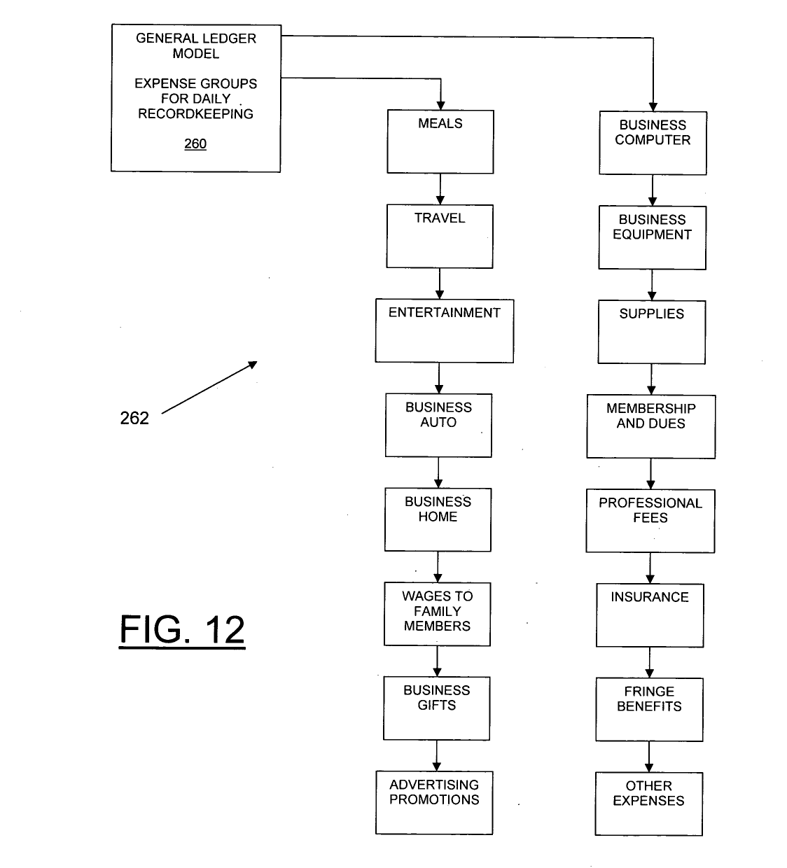

All business records 220 may be accessed continuously at all times by any interested party, from any geographic location. FIG. 11 provides an overview illustration of a typical access to different records by both professional counsel 200 and entities 20. As illustrated, system 2 provides accurate recording of various income and expense items while at the same time allowing continuous access by the tax professional 208 to assist entities 20 in reporting issues 220, report generation 220, and tax returns. The system allows the entity 20 to be fully informed about the nature and deductibility of various expense items, thus reducing errors in return preparation and filing, which translates into a more accurate return in case of an audit. Illustrated in FIG. 12 is a customized general ledger 262, showing a representative list of few expense categories for daily record keeping. Ledger 262 is obviously not an all-inclusive list. Every business record 220 generated by the system 2 is specific (or customized) to a particular industry classification, type, and jurisdictional requirements.

The delivery modes for system 2 are many and well known. Both the industry specific educational programs 12 and the industry specific professional programs 14 are readily available to both professional counsel 200 and others in a variety of well-known formats best suited for the particular topic of discussion. These may include, but are not limited to, manuals and worksheets, in person one-on-one support training or counsel, live on-line one-on-one support training or counsel, on-line training or counsel, class room setting in the place of business, school or any or all appropriate combinations suitable to the specific educational program 12 or professional programs 14. The delivery method of the different components of both the educational programs 12 and the professional programs 14 may be of any well known format that is appropriate to the topics under discussion, including for example, print, videos, CDs, on-line, various digital formats, or any or all suitable combinations. The digital file formats may be of any known type apt for the variety of educational 12 or professional 14 programs under discussion, and may include for example, doc, pdf, etc.

The on-line (live or otherwise) format for systems and services of the system 2 may be provided through any medium that enable members to communicate with one another and with professional counsel 200. The preferred method of communication would be through any well known means that would enable both visual as well as audio interactions between members and professional counsel 200. The well known formats also provides the capability for at least one professional counsel 200 to simultaneously train or counsel a multitude of entities across different jurisdictions, from any location. This may for example include the use of the Internet.

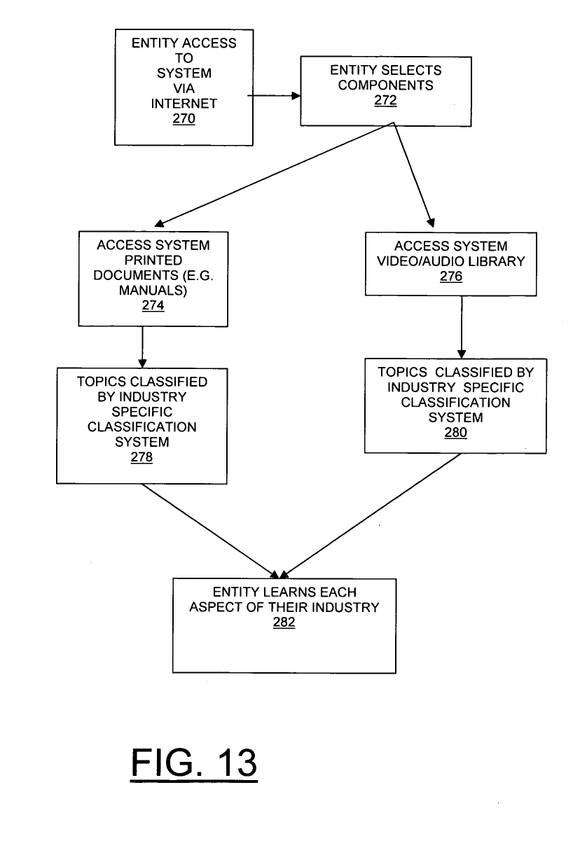

FIG. 13 illustrates a well-known method of access to system 2 on-line educational programs 12 via the Internet. After logging-in, the end user (entities 20 or professional counsel 200) may select from a variety of educational programs 12 available on-line in several well-known formats. The on-line “printed” format 274 may be of any sort suitable to the topic being discussed. These may include a variety of file formats such as pdf, doc, or any or all combinations appropriate for delivery of any topic of interest. The on-line “video” format 276 is a streaming video for any topic chosen by the end user 270. All topics for both formats are segregated into individual segments 278, 280 for quick and easy access to information relevant to the end user 20 or 200.

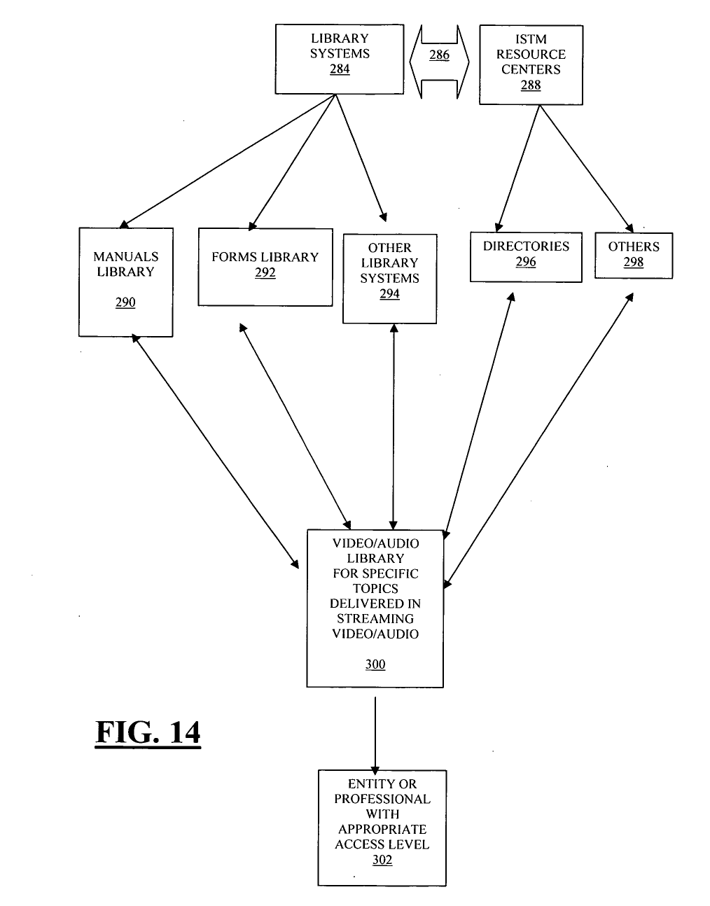

FIG. 14 is an exemplary illustration of two of the more than 12 libraries 284 and resource centers 288 located on the web site, including main on-line video libraries 290 and 292 of the educational programs 12. On-line video library 290 has an extensive collection of manuals, guides, business plans, worksheets, and others that are categorized by industry classification, type, and jurisdiction and may be accessed by any entity 20 or professional 200 from any location. The on-line video library 292 provides an extensive collection of different business forms for each specific industry group, type, and jurisdiction. Each topic available in all library 284 and resource centers 288 may be viewed or accessed by well known methods, including streaming videos 300 by end users 302. End users 302 may also access a variety of directories 296 available on-line as part of the library system 284 and resource center 288. The directories 296 provide general information (location, telephones, expertise, experience, etc.) about professional counsel 200 who are participants within the professional program 14 of system 2. Other directories 298 may include detailed information about all professionals 200 who were fully trained and certified under the system 2 educational programs 12, but may not be under an agreement 16 with system 2.

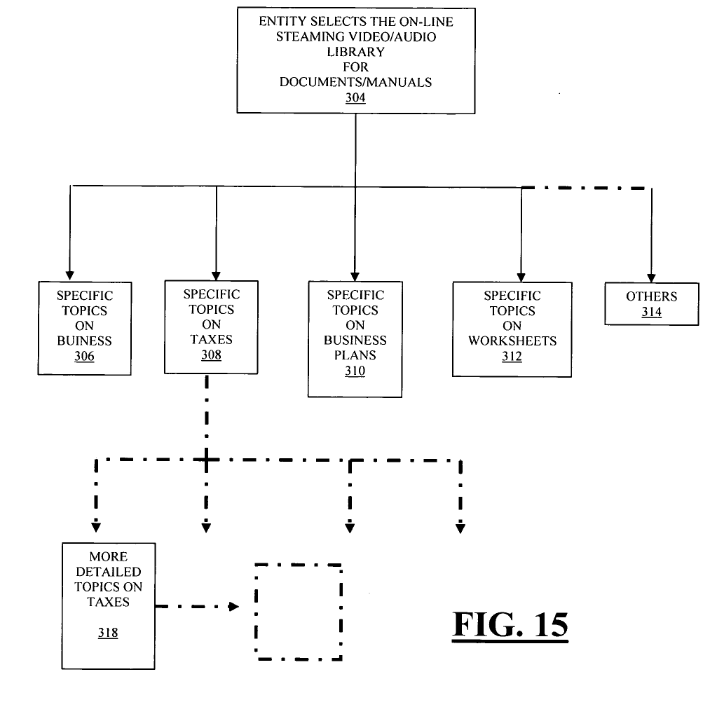

FIG. 15 illustrates some of the specific topics covered by the on-line video library 290. These may include manuals on a specific business 306, taxes 308, plurality of industry specific business plans 310, relevant worksheets 312, or any or all other topics 314 of interest required by an entity 20 or professional 200. Each of the topics further provides a subset of video streams that have even more detailed material and information specific to that topic. One such example is illustrated for the subject matter related to taxes 308, where a plurality of subset video streams 318 are available on each of the general topics covered by the video stream 308. Topics of interest to end-users are all specific to industry classification, type, and jurisdiction. For example, topics on business plans 310 may include general industry specific guidelines for a typical business plan that is most appropriate for that specific industry sector and segment. In addition, it further includes other details related to business formation issues within a specific jurisdiction.

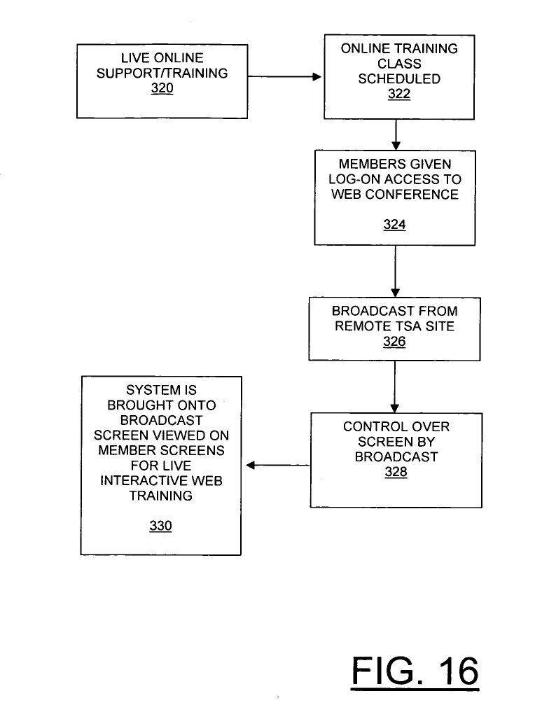

The educational programs 12 delivered in the well known method of live on-line interactive system is illustrated in FIG. 16, providing support and training 320 that can be scheduled 322 on-line for entities 20 or professionals 200. After a log-in session to a web conference “room” 324, the end users will be provided broadcast 326 from a remote site where software modules of system 2 reside. In these live on-line interactive sessions, the screens of all end users are fully controlled by the instructors through broadcast 328. The system 2 and all modules thereof may be brought onto broadcast screen, and viewed on member screens for live interactive web training 330.

In a live on-line environment conference, professional counsel 200 and their clients will have both audio and visual access to all documentation and records 220. The counsel 200 can have instantaneous and simultaneous access to at least one or more clients, including their records on computer screens through any known medium such as the Internet. Such access enables counsel 200 to discuss or describe any documentation or records 220 during the sessions with respective clients. These may for example include issues related to records 220, audits, substantiation requirements, and client's legal rights under the law or any or all topics of interest to clients. The technology for the live on line interactive conference is based on a plurality of well-known software applications available today.

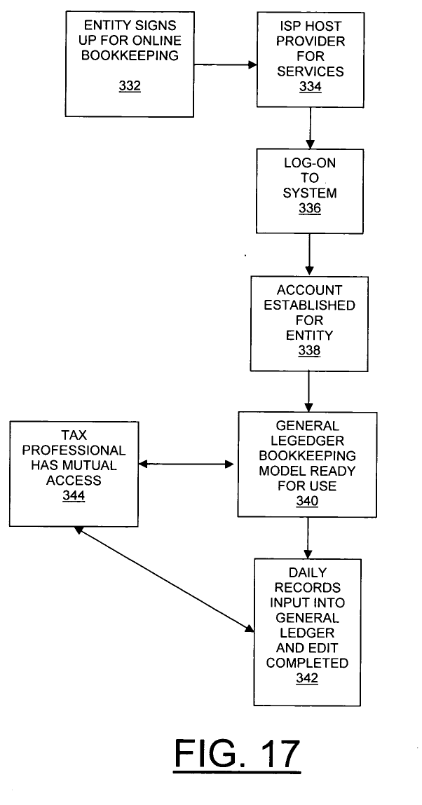

FIG. 17 is a specific exemplary illustration of a typical live on-line interactive session between a professional counsel 200 and an entity, under professional programs 14 of system 2 for bookkeeping. Any business record 220 may be brought into a live on-line session and not just topics related to taxes or bookkeeping. For example, business formation issues and any forms related thereto can be brought into an on-line session for both education and professional programs 12, 14. To access any live on-line industry specific professional programs 14, an entity 332 signs onto the system 336 through an Internet Service Provider (ISP) 334. A professional counsel 200 may generate, establish, edit, or perform a variety of business related functions in these sessions with direct mutual access 344 to the individuals or business's records 220. The visual portion of the sessions is such that professional counsel 200 will have full mutual control of the client's computer screen during the interactive conference. This enables the professional counsel 200 to “walk” the client systematically through even the most complicated business related tasks. The audio portion allows the professional counsel 200 to speak to the client during the session.

The advice provided by counsel 200 may be on any topic suitable for an on-line live interactive conference environment. For instance, if an individual living in one jurisdiction is interested in opening a garage shop, counsel will be provided through such sessions to train and assist this individual with respect to all aspects of this business. The topics may include business formation issues, marketing, taxes, equipment used in that business, financing, or any or all other business related issues that are of interest to the client. Of course, both the training and the assistance are always specific to industry groups and types, and targeted to any jurisdiction that the client is interested.

The employees 8 and the members of groups or association 10 are a special category of users of system 2 of the present invention. The educational and professional programs 12, 14 of system 2 are available to employees or members of associations or groups through sponsorship agreements 16 between the employer or the association and the system 2. The employee or member program through system 2 provides industry specific information and services related to taxes, employee or member resources, discounted employee or member services, and employee or member pre-paid audit protection to employees or members of an entity (business or an association) under agreement 16. The system 2 classifies, identifies, and provides resources for various specific occupational classifications in order to identify unique business or money related issues (such as taxes) for the specific occupational classes, while providing worksheets for the employees of a business or members of an association to use in record keeping of employee/member business/association related expenses as well as other general business information ranging from tax filing status to itemized deductions.

The program administration, tracking, deployment of resources, and program assets are made available to the employees of a business or members of an association through system 2 employee or member resource center (EMRC). The EMRC has the capability of customization to integrate the program sponsor employer or association identity onto the various assets and resources available to their respective employees or members through system 2. For example, system 2 can provide each employee/member within the classified group (illustrated in FIG. 2) with periodic business messages (such as a tips related to taxes) printed on any document that is disseminated by their respective employer or association on a periodic basis such as, for example, the employee payroll check stub for an employee. These industry specific grouped messages are designed to educate the employee or the member in looking at their money management methods in more detail. Under the employee or member program design, the system 2 provides customized identity to the employer or the association sponsor, advertising the employee or the member of the association that the employer or the association has sponsored the message. Each message is designed to provide information along with an action step to prompt the employee or the member to review further, information that is more specifics related to the topic in the message. This method of delivery along with the content is designed to take into account the occupational classification of the employee or member in many of the message formats being disseminated. For example, if the employee program of system 2 is provided to a restaurant, the waiters will be provided with different messages compared to other restaurant employees because waiters have different tax issues regarding the collection of gratuities.

The system 2 employee or member program has specific resources and assets available to each employee of a business or member of an association or group enrolled in the program. Among these resources as described above with respect to specific industry education 12 and the specific industry professional 14 programs, the system 2 includes practical illustration and how-to information along with custom designed worksheets that contribute to supporting the program for each enrollee. The specific industry educational program 12 for enrollees may include enrollee tax guides (specific to the occupational field of the employee/member), employee or member financial plan guides (e.g. financial plan, tax planning, retirement planning, etc.), and business use of home guide for enrollees who work from home. Other educational programs 12 resources may further include enrollee personal expense guide, tax organizer guide, audit guide, pre-paid audit protection coverage, enrollee discounts on tax services through industry specific professionals programs 14 of system 2, and enrollee consultations. As described above, each of the various resources and program assets are made available through a variety of delivery mediums, including the Internet to deliver resources and assets to employees or members in appropriate formats. The delivery medium also provides illustrated use and examples of the specific topics, integrates the employer or association sponsor identity onto the various resources, and provides useful instruction for the enrollee on using any or all of the various resources.

The employee or member program of system 2 may be provided as a working condition or membership fringe benefit to all employees of a business or members of an association. The industry specific professional services programs 14 is also available to each enrollee, and provides tax consulting services, enrollee discounts on tax related services, audit protection for employee or member enrolled, tax problem resolution services (e.g. tax liens, levies, etc.), and prior year tax reviews. The employee or member program of system 2 can be provided by the employer or association as an added benefit to employees or members, making the enrollee enrollment fees paid with pre-tax dollars depending upon the enrollment (an open enrollment election by the employee or member). The employer or association may also provide the employee/member program as a direct enrollment plan sponsored specifically by the employer or the association as a working or membership condition fringe benefit, as stated above. This would be a unified enrollment election by the employer or member.

Although the invention has been described in language specific to business features and or business methodological steps, it is to be understood that the invention defined in the appended claims is not necessarily limited to the specific features or steps described. Rather, the specific features and steps are disclosed as preferred forms of implementing the claimed invention. Accordingly, while illustrative embodiments of the invention have been described, numerous variations and alternative embodiments will occur to those skilled in the art. For example, the fee code system of the present invention may be modified to be numeric or non-numeric rather than alphanumeric. It may also include other characters that may better provide information to users. Such variations and alternate embodiments are contemplated, and can be made without departing from the spirit and scope of the invention.

What is claimed is:

1) A specific business method for consulting and managing a business entity by providing tax strategies accounting and finance methods, and wealth services for individual companies and their owners each comprising:
performing an audit of a company's current business entity, taxes, accounting methods and finance documents;
determining whether said company's past taxes need to be amended, abated or recovered;
submitting relevant documentation to an appropriate governmental department for any of the company's taxes that are to be amended and resulting in a tax refund, abatement, and definition of a new tax centered strategy;
determining whether said company's current business entity is appropriate for thecompany's business model, resulting in a redefined business entity;
submitting appropriate documentation to an appropriate state governmental department for any modification of the company's current business entity;
determining whether said company's accounting methods and financing should be changed, amended or modified resulting in a recommended accounting program;
providing the appropriate consulting methods as necessary to support and train company representatives to implement any recommended accounting program and tax-centered strategy; and
providing a specific software accounting module, software tax module and software financial module for the company to comply with the recommended business entity, accounting methods and tax-centered strategy.

2) A business method as recited in claim 1, wherein said accounting module, tax module and financial module are designed to uniquely cooperate together and share relevant databases.

3) A business method as recited in claim 1, wherein said audit of a company's taxes is conducted on past tax filings up to the statutory period, if any.

4) A business method as recited in claim 1, wherein said federal government department is the United States Internal Revenue Service.

5) A business method as recited in claim 1, wherein said appropriate state government department is one of the Secretary of State organized under one of the fifty states of the United States.

6) A business method as recited in claim 1, further comprising that said business entity may be more than one business or corporate entity.

7) A business method as recited in claim 1, further comprising that said business entity may be more than one type of entity.

8) A business method as recited in claim 1, wherein said consulting services employs attorneys, certified public accountants, tax preparers and accounting specialists to provide said consulting services.

9) A business method as recited in claim 1, wherein said software accounting module, tax module and entity module are updated annually.

10) A specific business method for consulting and managing a business entity by providing tax strategies accounting and finance methods, and wealth services for individual companies and their owners each comprising:
performing an audit of a company's current business entity, taxes, accounting and finance documents;
determining whether said company's taxes need to be amended, abated or recovered;
submitting relevant documentation to an appropriate governmental department for any of the company's taxes that are to be amended resulting in a tax strategy;
implementing a specific software tax module;
determining whether said company's current corporate entity is appropriate for the company's business model resulting in a recommended corporate entity;
submitting appropriate documentation to an appropriate state government department for any modification of the company's current corporate entity;
implementing a company specific entity module;
determining whether said company's accounting methods and financing should be amended or modified resulting in a recommended accounting program;
implementing a company specific accounting module; and
providing the appropriate consulting services as necessary to support and train company representatives to implement any recommended accounting program and tax strategy.

11) A business method as recited in claim 10, wherein said accounting module, tax module and financial module are designed to cooperate together and share appropriate databases.

12) A business method as recited in claim 10, wherein said audit of a company's taxes is conducted on past tax filings up to the statutory period.

13) A business method as recited in claim 10, wherein said federal government department is the United States Internal Revenue Service.

14) A business method as recited in claim 10, wherein said appropriate state government department is one of the Secretary of State organized under one of the fifty states of the United States.

15) A business method as recited in claim 10, further comprising that said corporate entity may be more than one corporate entity.

16) A business method as recited in claim 10, further comprising that said corporate entity may be more than one type of entity.

17) A business method as recited in claim 10, wherein said consulting services employs attorneys, certified public accountants and accounting specialists to provide said consulting services.

18) A business methods as recited in claim 10, wherein said software accounting module, tax module and entity module are updated annually.
